(19) United States
(12) Patent Application Publication
(10) Pub. No.: US 2021/0037322 A1
(43) Pub. Date: Feb. 4, 2021

(54) Techniques for Providing Acoustic Impedance Matching for a Broad-Band Ultrasonic Transducer Device and a Method of Wildlife Deterrence Using Same

(71) Applicant: NRG SYSTEMS, INC., Hinesbury, VT (US)

(72) Inventors: Dale E. Williams, Winooski, VT (US); Cody G. Spiegel, Charlotte, VT (US)

(21) Appl. No.: 17/066,393

(22) Filed: Oct. 8, 2020

Related U.S. Application Data
(63) Continuation of application No. PCT/US2019/026798, filed on Apr. 10, 2019.

(51) Int. Cl. H04R 11/14; H04R 7/04

(52) U.S. Cl. CPC H04R 11/14; H04R 7/045

(57) ABSTRACT

A system and method for providing effective acoustic impedance matching for a broadband ultrasonic transducer device (UTD) by adding at least one impedance matching plate (IMP) and a shim to the UTD. The IMP is a flat plate with a grid of holes and the shim is disposed between the IMP and the ultrasonic transducer, e.g. piezoelectric transducer, of the UTD.

### CROSS-REFERENCE TO RELATED APPLICATIONS

This application is a continuation of International Patent Application Serial No. PCT/US2019/026798, filed Apr. 10, 2019, designating the U.S. and claiming the benefit of the filing date of U.S. Provisional Application Ser. No. 62/655,715, filed Apr. 10, 2018, the teachings of which are hereby incorporated herein in their entirety.

### TECHNICAL FIELD

The present disclosure generally relates to ultrasonic transducer devices, and more particularly, to techniques for providing acoustic impedance matching for a broad-band ultrasonic transducer device and a method of wildlife deterrence using the same.

### BACKGROUND INFORMATION

Many forms of renewable energy, such as wind turbines, may endanger wildlife such as bats and other animals that have habitats in close proximity thereto. Some solutions to deterring wildlife from dangerous areas include using acoustic transducer devices such as ultrasonic transducer devices (UTDs) that output specific frequencies and sound pressure levels. For example, a wind turbine structure may include a plurality of UTDs disposed at strategic locations to prevent bats from entering the area of the turbine blades and being injured by the blades.

One challenge in operating UTDs is that the ultrasound energy from the UTDs attenuates rapidly over distance in the surrounding air. To help compensate for this rapid attenuation, coupling of energy from a UTD to air can be optimized by use of an acoustic impedance matching device. Common acoustic impedance matching devices include horns and one-quarter wavelength matching layers. These devices have drawbacks due to material properties, cost to manufacture, difficulty to manufacture, physical size, effect on beam angle, thermal dissipation and robustness to certain environments.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 diagrammatically illustrates one example of a broadband ultrasonic transducer device (UTD) consistent with the present disclosure.

FIG. 2 is a perspective view of one example of a UTD consistent with the present disclosure.

FIG. 3 is an exploded view of a sub-array consistent with the present disclosure.

FIG. 4 is a back, perspective view of the sub-array illustrated in FIG. 3.

FIG. 5 is a cross-sectional view of the sub-array illustrated in FIG. 3.

FIG. 6 is a front view of an impedance matching plate consistent with the present disclosure.

FIG. 7 is a back view of an impedance matching plate and shim consistent with the present disclosure.

FIG. 8 is a cross-sectional view of the sub-array illustrated in FIG. 3.

FIG. 9 is a cross-sectional view of a sub-array illustrated in FIG. 3 including exaggerated dimensions.

FIG. 10 is an exploded view of another sub-array consistent with the present disclosure.

FIG. 11 is a sectional view of a portion of the sub-array illustrated in FIG. 10.

FIG. 12 is a sectional view of another portion f the sub-array illustrated in FIG. 10.

### DETAILED DESCRIPTION

A system and method consistent with the present disclosure provides effective acoustic impedance matching for a broadband ultrasonic transducer device (UTD) by adding one or more impedance matching plate(s) (IMP(s)) and one or more shim(s) to the UTD. An IMP is a flat plate with a grid of holes and the shim is placed between the IMP and the ultrasonic transducer, e.g. piezoelectric transducer, of the UTD. The shim may be a separate component, e.g. a metal foil, or may be integral with an IMP, e.g. an IMP and shim may be machined from a single piece of material. In general, the shim(s) create a thin, precise air gap between the surface of the ultrasonic transducer and the IMP(s). In operation this thin air gap creates a high-pressure region resulting in higher loading on the traducer surface than would occur without the shim(s) This higher loading provides an increase in efficiency of energy transfer from the transducer into the air, resulting in higher sound pressure level. The pressure waves generated by the transducer propagate through the grid of small holes causing each of the holes to become an acoustic radiator.

The physical design of the IMP(s) may be different depending on the natural frequency of the associated ultrasonic transducer and the material from which the transducer is constructed. The hole size, grid spacing, plate thickness and shim thickness can be optimized for specific transducers, and the IMP(s) and shim(s) may be constructed to provide impedance matching for an array of transducers. Also, depending on the IMP configuration the beam angle of the resulting UTD configuration can be minimally affected or optimized.

Advantageously, the IMP(s) may be constructed, e.g. machined, from metal or a metal alloy and thermally coupled to the ultrasonic transducer, e.g. through a subassembly and the shim, allowing the IMP(s) to act as a heat sink for the transducer. This allows the UTD to achieve higher sound pressure levels because the transducer may be driven at high voltages without overheating. Also, the IMP(s) may be coupled to the UTD, e.g. using common fasteners and/or adhesives, at many locations to ensure the IMP(s) sit flat against the UTD keeping the airgap established by the shim uniform across the surface of the UTD. Coupling the IMP(s) to the UTD also allows for a compact assembly. In addition, the IMP(s) and the shim(s) may be constructed using standard manufacturing processes from materials, e.g. metals or metal alloys, traditionally used in harsh environments.

Embodiments of a system and method consistent with the present disclosure will be described herein in connection with a broadband UTD including a housing portion configured to couple to a plurality of piezo sub-arrays or piezo sub-array plates. Each piezo sub-array plate includes a plurality of machined pockets or cavities to receive respective narrow-band (e.g., 1 kHz-3 kHz) piezo electro transducer elements with characteristics, e.g., geometries, material composition, that cause each piezo sub-array plate to emit ultrasonic energy at a nominal resonant frequency. Each piezo sub-array plate therefore emits at a single-frequency, with each of the associated piezo elements, in a general sense, amplifying that single-frequency. The housing portion of the broadband UTD includes an array of the piezo sub-array plates to provide broadband emission capabilities, which is particularly advantageous in deterrent unit (DU) applications for deterring wildlife from an area associated with the DU.

One such example bandwidth of interest particularly well-suited for wildlife deterrence is 20 kHz to 60 kHz, which is the range of frequency that characterize white noise. Note a broadband UTD configured in accordance with the present disclosure is not necessarily limited to a frequency in the range of 20 kHz and 60 kHz, and may be configured to output other frequencies up to and exceeding 100 kHz, for instance, depending on a desired configuration.

Although embodiments are described herein with reference to a specific configuration and application for a UTD, it is to be understood that one or more IMPs and shims configuration consistent with the present disclosure may be used in a variety of applications for providing acoustic impedance matching. Also, embodiments are described herein in connection with ultrasonic transducers. It is to be understood that a system and method consistent with the present disclosure is not limited to ultrasonic transducers and may be implemented with other types of acoustic transducers. Also, although example embodiments may be described herein in connection with piezo-electric transducers a system and method consistent with the present disclosure is not limited to use of piezo-electric transducers and may be implemented without types of transducers such as electromagnetic acoustic transducers.

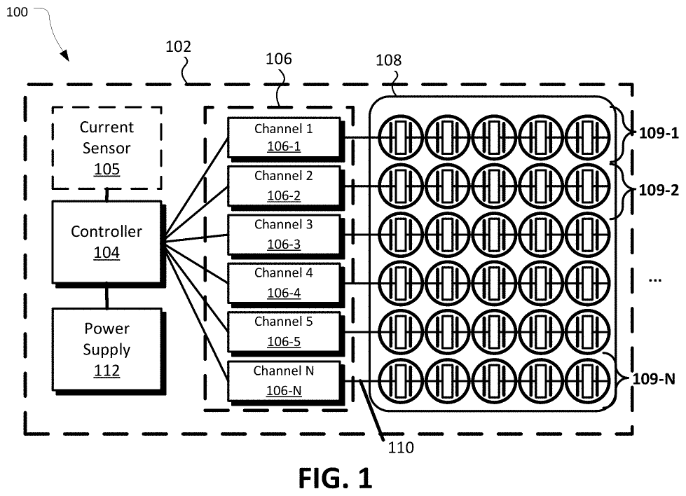

FIG. 1 diagrammatically illustrates one example of a broadband ultrasonic transducer device (UTD) 100 consistent with the present disclosure. The broadband UTD 100 is shown in a highly simplified form and other embodiments are also within the scope of this disclosure. As shown, the broadband UTD 100 includes a housing 102. The housing 102 includes a controller 104, a plurality of channels collectively shown as channel drivers 106 and individually shown as channel drivers 106-1 . . . 106-N, an array of piezo electric transducers 108, and power supply circuitry 112.

Various scenarios and examples disclosed herein include the use of the broadband UTD 100 in outdoor environments or any other environment that requires consideration as to dust, heat, moisture and other conditions. The housing 102 may be ruggedized and sealed to prevent ingress of such contaminants. In some cases, the housing 102 comprises a plastic, polycarbonate, or any other suitably rigid material.

While the example embodiment of FIG. 1 shows each component within the housing 102, this disclosure is not necessarily limited in this regard. For instance, the power supply circuitry 112 and controller 104 may not reside, e.g., be collocated, in the housing 102 along with the channel drivers 106 and the array of piezo electrical transducers 108. Numerous other alternatives and permutations are within the scope of this disclosure.

The controller 104 comprises at least one processing device/circuit such as, for example, a digital signal processor (DSP), a field-programmable gate array (FPGA), Reduced Instruction Set Computer (RISC) processor, x86 instruction set processor, microcontroller, or an application-specific integrated circuit (ASIC). Aspects of the controller 104 may be implemented using, for example, software (e.g., C or C++ executing on the controller/processor 104), hardware (e.g., hardcoded gate level logic or purpose-built silicon) or firmware (e.g., embedded routines executing on a microcontroller), or any combination thereof.

The power supply circuitry 112 may be any suitable arrangement for supplying power to the broadband UTD 100. The power supply circuitry 112 may be configured to receive power from an external source (e.g., from AC main) and/or via one or more batteries (not shown). Although the power supply 112 is shown electrically coupled to the controller, the power supply 112 may couple to each of the channel drivers 106, for example, to provide power during operation of the broadband UTD 100.

Each of the channel drivers 106 may include amplification circuitry and piezo driver circuitry to drive associated piezo electric transducers of the array of transducers 108 based on a signal received from the controller 104, for example. Each of the piezo electric transducers of the array of transducers 108 may be implemented as enclosed-type transducers, which may be hermetically sealed. Enclosed-type transducers may be particularly advantageous for outdoor environments as they prevent against ingress of contaminants, and also for indoor environments characterized by dust and/or other contaminates. Each of the piezo electric transducers may include a metal housing with an integral metal diaphragm. A back of each piezo electric transducer may be completely sealed with a resin or other suitable sealant to protect from ingress of contaminants in a given environment. Other piezo electric transducer devices are within the scope of this disclosure, e.g., unenclosed types, and this disclosure should not be construed as limiting in this regard.

Each of the channel drivers 106-1 . . . 106-N is associated with a corresponding sub-array, 109-1 . . . 109-N, respectively, of piezo electric transducer devices (also referred to herein as piezo transducer elements). Although five (5) piezo electric transducers are shown in each sub-array 109-1 . . . 109-N, this disclosure should not be limited in this regard. For example, each of the channel drivers 106-1 . . . 106-2 may be associated with a sub-array 109-1 . . . 109-N of 2, 5, 7, 10, or any number of piezo electric transducers depending on a desired configuration. In any event, each channel driver and associated sub-array 109-1 . . . 109-N may be collectively referred to as a “channel” or “output channel” herein. Thus, the channel driver 106-1 and sub-array 109-1 may be collectively referred to as Channel 1; channel driver 106-2 and associated sub-array 109-2 may be referred to as Channel 2, and so on.

Each piezo electric transducer of the array of transducers 108 may be configured substantially the same. For the sake of providing a specific non-limiting example, each of the piezo electric transducers of the array of transducers 108 may be implemented with a center frequency of 25 KHz±lKhz, a minimum sound pressure level of 113 dB, and a bandwidth of about 1.0 KHz. In other cases, different piezo electric transducer devices may be utilized. As discussed below, the physical characteristics of each piezo sub-array plate determine resonant frequency, and therefore, properties of the pocket/cavity coupled to each piezo electric transducer may be varied to achieve a nominal resonant frequency.

Each channel of the UTD 100 may thus be associated with an output frequency that is unique relative to the other channels based on the particular piezo transducer element used and the properties of the associated cavity/pocket which a piezo transducer element is coupled to. Each channel of the UTD 100 further includes a plurality of output resonant frequencies based on the bandwidth of a piezo electric transducer element. For example, each piezo electric transducer element may include a ±6 kHz bandwidth, although other bandwidths are within the scope of this disclosure. By way of example, consider Channel 1 having a nominal/design resonant frequency of about 25 KHz. In this example, the upper frequency and lower frequency values associated with this nominal frequency may include frequencies ranging from 28 kHz to 22 kHz, respectively. Channel 1 may therefore be driven to emit/output a resonant frequency in the range of 22 kHz to 28 kHz without endangering or otherwise degrading performance of the piezo electric transducers 109-1. Channel 2 may likewise be configured to be driven to emit/output a resonant frequency in the range of 29 kHz to 35 kHz based on a center frequency of 32 kHz, for example. Therefore, in accordance with an embodiment each channel of the broadband UTD 100 may be configured to cover an exclusive, non-overlapping range of resonant frequencies. In other cases, the broadband UTD 100 may be configured with channels having overlapping ranges or at least partially-overlapping ranges, e.g., that overlap by at least 1 kHz.

In operation, the controller 104 provides a signal, e.g., a square wave, to each of the channel drivers 106 to cause an associated sub-array 109-1 . . . 109-N to emit at a particular resonant frequency. The controller 104 may select a particular output frequency for a given channel by providing a signal to associated channel driver circuitry with a proportional frequency. A duty cycle of the signal provides the “on time” versus the “off time”, which is to say the period of time when piezo electric transducers emit a particular output frequency versus the period of time when piezo electric transducers are off (or de-energized). Channel on time may be governed by a dwell time parameter. The overall ratio of on time to off time may be roughly equal, e.g., to provide a 50% duty cycle, although other duty cycles are also within the scope of this disclosure.

In some embodiments consistent with the present disclosure the controller 104 may cause one or more channels to emit a respective frequency simultaneously, with the maximum number of simultaneously emitted frequencies being equal to the total number of channels. For example, in a six (6) channel arrangement, such as shown in FIG. 1, the controller 104 may cause each of Channels 1 . . . 6 to emit six different frequencies simultaneously. To achieve a particular desired waveform, e.g., such as a white noise or colored noise waveform, the controller 104 may selectively drive one or more channels “on” while leaving others off in a random pattern.

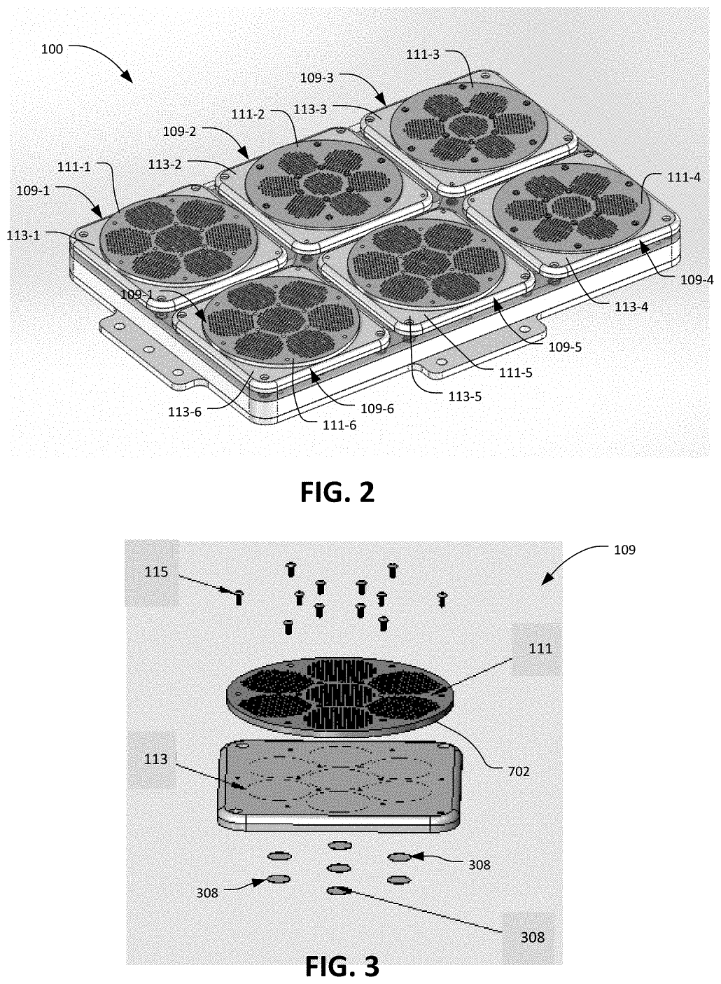

FIG. 2 shows an embodiment of a broadband UTD 100 consistent with the present disclosure. As shown, the broadband UDT 100 includes an elongated rectangular housing 16 having six sub-arrays 109-1 . . . 109-6 coupled thereto. The housing 16 may comprise, for example, a metal or metal alloy, e.g. aluminum or any other suitably rigid material. Each of the sub-arrays 109-1 . . . 109-6 includes associated piezo electric transducers having an identical or substantially similar nominal frequency and is coupled to the housing 16 via one or more fastening member such as one or more screws 403. Each of the sub-arrays 109-1 . . . 109-6 may be acoustically (e.g., vibrations from adjacent sub-arrays 109-1 . . . 109-6 have negligible or otherwise no effect) and electrically isolated from each other.

Advantageously, each of the sub-arrays 109-1 . . . 109-6 includes an associated impedance matching plate (IMP) (111-1 . . . 111-6) coupled to an associated sub-array plate 113-1 . . . 113-6. The IMP 111-1 . . . 111-6 of each sub-array 109-1 . . . 109-6, in combination with an integral or separate shim (See FIGS. 7-9) provides acoustic impedance matching for the energy output from the piezo electric transducers associated with the sub-array 109-1 . . . 109-6. This impedance matching provides an increase in efficiency of energy transfer from the transducer into the air, resulting in higher sound pressure level. Also, in some embodiments, the IMP 111-1 . . . 111-6 of each sub-array 109-1 . . . 109-6 may be thermally coupled (e.g. by direct contact with the sub-array plates 113-1 . . . 113-6 and/or the fasteners) to the piezo electric transducers. This allows the sub-arrays 109-1 . . . 109-6 to achieve high sound pressure levels because the piezo electric transducers associated therewith may be driven at high voltages without overheating.

FIG. 3 is an exploded view of one embodiment of a sub-array 109 consistent with the present disclosure. The illustrated embodiment includes seven piezo electric transducers 308, a sub-array plate 113, an IMP 111 and fasteners 115 for fastening the IMP 111 to the sub-array plate 113. A shim 702 is provided on the bottom of the IMP. The shim 702 is seen more clearly and is described in more detail below in connection with the exaggerated view provided in FIG. 9.

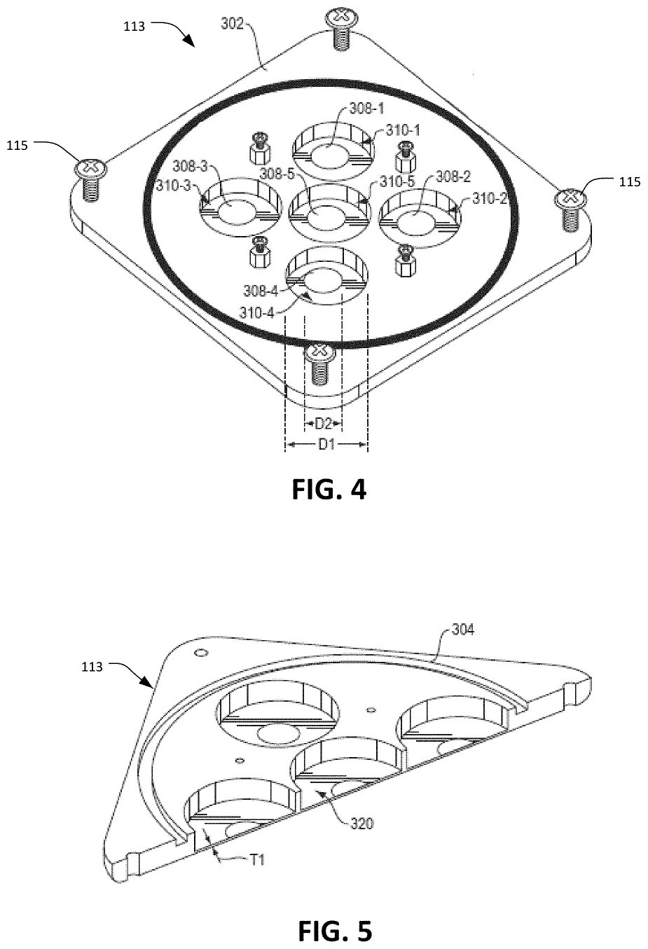

FIG. 4 is a back, perspective view of the sub-array 109 shown in FIG. 3. The illustrated sub-array plate 113 includes a base 302 or base portion 302 that may be comprised of, for example, aluminum or other suitable material. The base portion 302 includes a plurality of openings, e.g., opening 310-1 . . . 310-5, formed therein. Each opening 310-1 . . . 310-5 may be configured to receive a respective piezo electric transducer 308-1 . . . 308-5. The openings 301-1 . . . 310-5 may be also be referred to as cavities or pockets. The openings 310-1 . . . 310-5 may be formed via milling or other suitable approach. Accordingly, each opening 310-1 . . . 310-5 may include a first diameter D1 that is larger than a diameter of an associated piezo electric transducer. Each opening 310-1 . . . 310-5 may further include at least an upper portion or cavity having the diameter D1 and a secondary/lower portion with a second diameter D2. The second diameter D2 may be configured substantially equal to that of the diameter of a respective piezo electric transducer. As shown, each of the piezo electric transducers 308-1 . . . 308-5 are disposed in a respective pocket of an associated opening 310-1 . . . 310-5, with a top surface of each piezo electric transducer being visible. In some cases, each of the piezo electric transducers 308-1 . . . 308-5 are secured in their respective pockets using an adhesive, for example.

FIG. 5 is a cross-sectional view of the example piezo sub-array plate 113. In a known manner, each piezo sub-array plate 113 may be specifically designed to emit a particular resonant frequency based on physical and material features such as diameter of an associated opening, e.g., diameter D1, the thickness of the material adjacent each piezo electric transducer, e.g., thickness T1 of a bending element 320, and the Young's Modulus of the material of the material adjacent each piezo electric transducer. The bending element 320, may be formed from other materials and is not necessarily limited to a metal or metal alloy.

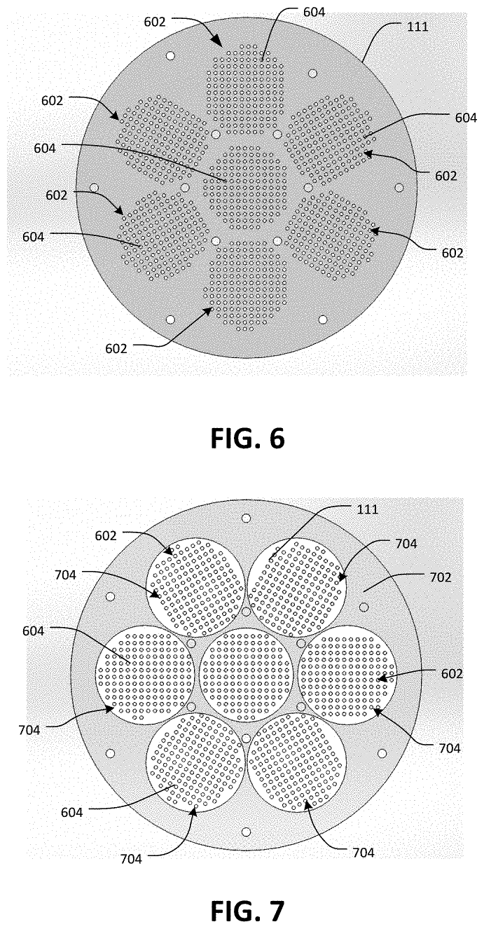

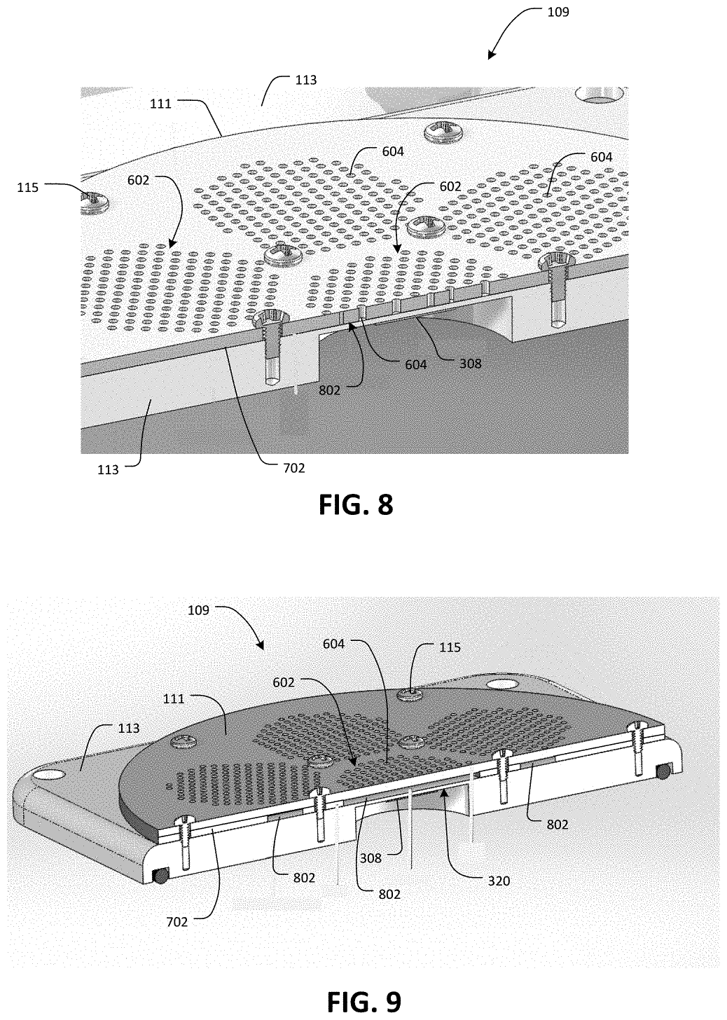

FIG. 6 is a front view of the example IMP 111. The IMP 111 may be machined, e.g. using an etching process such as photochemical etching, from a metal or metal alloy, e.g. chosen to provide thermal conductivity an act as a heat sink for the piezo electric transducers 308-1 . . . 308-5. As shown, the IMP may include a plurality of separate regions 602 of holes 604 formed therein. With reference also to FIGS. 8-9 for example, each of the regions 602 of holes 604 is positioned to overlie an associated one of the bending elements 320 of an associated one of the openings opening 310-1 . . . 310-5 when the sub-array plate 113 is assembled.

FIG. 7 is a back view of the example IMP 111 and a shim 702. The shim 702 extends from the bottom surface of the IMP 111 and includes openings 704 corresponding to and aligned with the regions 602 of holes 604 in the IMP 111. The shim 702 may be integrally formed with the IMP 111 and/or the sub-array plate 113, e.g. machined from the same material, or may be a separate component configured to be positioned between the bottom surface of the IMP 111 and the top surface of the sub-array plate 113. In some embodiments, the shim 702 may be a separate component from the IMP 111 and may be coupled to the bottom surface of the IMP 111 using, for example, an adhesive. In embodiments wherein the shim 702 is a separate component form the IMP 111, the shim may be manufactured using printed circuit board manufacturing techniques, e.g. etching. The shim may be formed comprise a metallic material (metal or metal alloy) to provide a thermal pathway from the piezo electric transducer 308, through the sub-array plate 113 and the shim 702, to the IMP 111, thereby allowing the IMP 111 to act as a heat sink for the piezo electric transducer 308.

FIG. 8 is a sectional view of the sub-array 109 and FIG. 9 is a sectional view of a sub-array 109 including exaggerated relative dimensions of the shim 702 to more clearly illustrate the air gaps 802 formed by the shim 702. As illustrated in FIGS. 8 and 9, when the sub-array 109 is assembled, the bottom surface of the shim 702 is in contact with the top surface of the sub-array plate 113 and a top surface of the shim 702 is in contact with the bottom surface of the IMP 111. In some embodiments, the shim 702 is integral with the IMP 111 and extends from a bottom surface of the IMP 111.

The openings 704 in the shim 702 align with associated regions 602 of holes 604 and with the bending elements 320 associated with the piezo electric transducer 308 to establish air gaps 802 between the bending elements 320 and associated regions 602 of holes 604 in the IMP 111. In operation the air gap 802 creates a high-pressure region resulting in higher loading on bending element 320 than would occur without the shim 702. This higher loading provides an increase in efficiency of energy transfer from the piezo electric transducer 308 into the air, resulting in higher sound pressure level. The pressure waves generated by the piezo electric transducer 308 propagate through the holes 604 causing each of the holes 604 to become an acoustic radiator.

A UTD 100 consistent with the present disclosure may be provided in a variety of configurations and is not limited to the specific configurations shown herein. In one embodiment consistent with the present disclosure, a UTD 100 may include six sub-arrays 109-1 . . . 109-6, e.g. as illustrated in FIG. 2. The sub-arrays 109-1 . . . 109-6 may be configured to operate at nominal frequencies of 20 KHz, 26 KHz, 32 KHz, 38 KHz, 44 KHz, 50 KHz, respectively. The IMPs 113-1 . . . 113-6 for all the respective sub-arrays 109-1 . . . 109-6 may include holes 604 of 1 mm in diameter on a 1.9 mm grid. For the 38 KHz, 44 KHz and 50 KHz sub-arrays a 30 um air gap 802 may be established using a 0.064″ thick IMP 111. For 26 KHz and 32 KHz sub-arrays a 30 um air gap 802 may be established using a 0.115″ thick IMP 111. For the 20 KHz sub-array a 60 um air gap 802 may be established using a 0.115″ thick IMP 111. A variety of other configurations for the UTD may be established in a manner consistent with the present disclosure depending upon the application. For example, in some embodiments an IMP consistent with the present disclosure may include a non-planar top surface.

In some embodiments, multiple IMPs with the same or different thicknesses may be stacked to establish a desired overall thickness of the IMP stack for impedance matching. In addition, or alternatively, multiple shims of the same or different thicknesses may be stacked to establish a desired overall thickness of the airgap for impedance matching. Using multiple thin IMPs and/or shims allows for accurate machining of the IMPs and the shims from a variety of materials using etching techniques, e.g. photoetching, with high production at low cost.

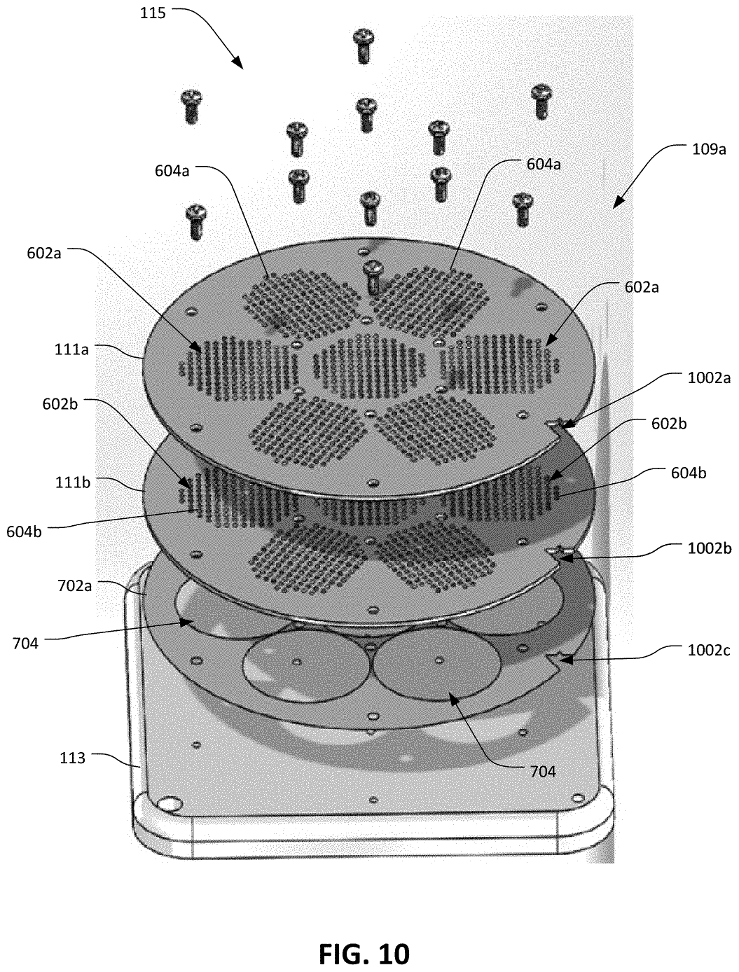

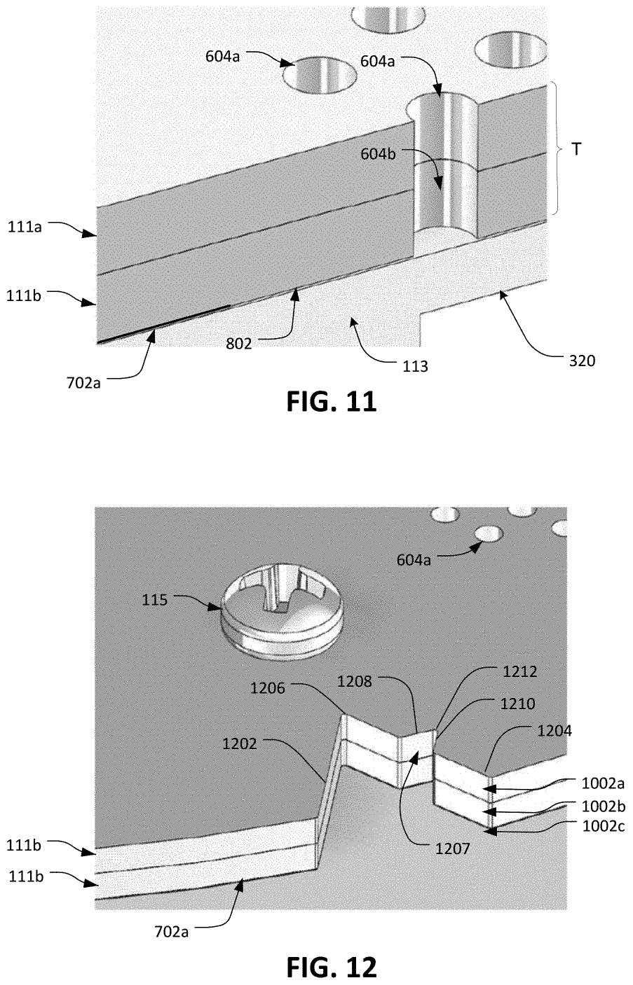

For example, FIG. 10 is an exploded view of one embodiment of a sub-array 109a consistent with the present disclosure including two IMPs 111a, 111b, a shim 702a, a sub-array plate 113 and fasteners 115 for fastening the IMPs 111a, 111b and the shim 702a to the sub-array plate 113. The IMPs 111a, 111b have nominally the same configuration, so they may be stacked to provide a desired overall thickness T (FIG. 11). To facilitate assembly, the IMPs 111a, 111b and the shim 702a each includes an associated alignment feature 1002a, 1002b and 1002c, respectively.

FIGS. 11 and 12 are sectional views of different portions of the sub-array 109a shown in FIG. 3. In general, the sub-array 109a is the same as the sub-array 109 illustrated in FIGS. 8 and 9, except for the inclusion of two IMPs 111a, 111b instead of one IMP 111 and addition of the alignment features 1002a, 1002b, 1002c. When the sub-array 109a is assembled, the bottom surface of the shim 702a is in contact with the top surface of the sub-array plate 113, a top surface of the shim 702a is in contact with the bottom surface of the IMP 111a and a bottom surface of the IMP 111b is in contact with the top surface of the IMP 111a. In some embodiments, the shim 702a is integral with the IMP 111a and extends from a bottom surface of the IMP 111a.

The IMPs 111a, 111b each include a plurality of separate regions 602a, 602b of holes 604a, 604b formed therein. Each of the regions 602a, 602b of holes 604a, 604b is positioned to overlie an associated one of the bending elements 320. When the sub-array 109a is assembled, the IMPs 111a, 111b are stacked so that the holes 604a in the IMP plate 111a align with (e.g. are nominally concentric with) the holes 604b in the IMP plate 111b, as shown in FIG. 11. The openings 704 in the shim 702a align with associated regions 602a, 602b of holes 604a, 604b and with the bending elements 320 associated with the piezo electric transducer 308 to establish air gaps 802 between the bending elements 320 and the regions 602a of holes 604a of the IMP 111a.

Alignment of the holes 604a, 604b in the IMPs 111a, 111b and the openings 704 in the shim 702a may be accomplished during assembly using the alignment features 1002a, 1002b and 1002c. In the illustrated example embodiment, the IMPs 111a, 111b and the shim 702a each include an alignment feature 1002a, 1002b and 1002c of nominally the same size and shape. The alignment features may be any feature, e.g. a notch and/or projection, that facilitates alignment of the holes 604a, 604b in the IMPs 111a, 111b and the openings 704 in the shim 702a.

In the illustrated example embodiment, the alignment features 1002a, 1002b and 1002c are configured as notches formed in the IMPs 111a, 111b and the shim 702a. With reference to the IMP plate 111b, in the illustrated example embodiment, the alignment feature 1002a is a V-shaped notch defined by opposed side surfaces 1202, 1204 that extend inward from a perimeter of the IMP 111b and join at an apex 1206. A sub-notch 1207 is formed in the side surface 1204. In the illustrated example, the sub-notch 1204 is V-shaped and is defined by sub-notch side surfaces 1208, 1210 extending from the side surface 1204 and joining at a sub-notch apex 1212. During assembly, the IMPs 111a, 111b and shim 702a are installed on the sub-array plate 113 with the fasteners 115 loose. A tool (not shown) having the same shape as the alignment features 1002a, 1002b, 1002c is inserted into the alignment features 1002a, 1002b, 1002c to align the IMPs 111a, 111b and the shim 702a and the fasteners 115 are tightened before the tool is removed.

In accordance with an aspect of the present disclosure there is disclosed an acoustic transducer device including: a plate including a plurality of openings therein; a plurality of transducer elements, each being coupled to a bending element of a respective opening of the plurality of openings; an impedance matching plate including a plurality of regions of holes formed therein, each of the regions of holes being positioned over an associated one of the bending elements; and a shim disposed between the plate and the impedance matching plate, the shim including a plurality of openings therein, each of the openings being positioned over an associated one of the bending elements to establish an air gap between the associated one of the bending elements and an associated one of the regions of holes of the impedance matching plate. In some embodiments, the impedance matching plate is thermally coupled to the plurality of transducer elements through the shim and the bending elements to act as a heat sink for the transducer elements.

In accordance with another aspect of the disclosure, there is provided an ultrasonic transducer device (UTD), including: a plurality of sub-arrays coupled to a base portion, each of the sub-arrays being associated with a nominal resonant frequency and comprising a sub-array plate including a plurality of openings therein; a plurality of transducer elements, each being coupled to a bending element of a respective opening of the plurality of openings; an impedance matching plate including a plurality of regions of holes formed therein, each of the regions of holes being positioned over an associated one of the bending elements; and a shim disposed between the sub-array plate and the impedance matching plate, the shim including a plurality of openings therein, each of the openings being positioned over an associated one of the bending elements to establish an air gap between the associated one of the bending elements and an associated one of the regions holes of the impedance matching plate. In some embodiments, the impedance matching plate is thermally coupled to the plurality of transducer elements through the shim and the bending elements to act as a heat sink for the transducer elements. The UTD further includes driver circuitry electrically coupled to each of the plurality of sub-arrays, the driver circuitry configured to cause each of the sub-arrays to emit ultrasonic energy based on the nominal resonant frequency associated with each sub-array.

In accordance with another aspect of the disclosure, there is provided method of deterring wildlife from an area including: providing a plurality of sub-arrays coupled to a base portion, each of the sub-arrays being associated with a nominal resonant frequency and comprising a sub-array plate including a plurality of openings therein; a plurality of transducer elements, each being coupled to a bending element of a respective opening of the plurality of openings; an impedance matching plate including a plurality of regions of holes formed therein, each of the regions of holes being positioned over an associated one of the bending elements; and a shim disposed between the plate and the impedance matching plate, the shim including a plurality of openings therein, each of the openings being positioned over an associated one of the bending elements to establish an air gap between the associated one of the bending elements and an associated one of the regions of holes of the impedance matching plate. In some embodiments, the impedance matching plate may be thermally coupled to the plurality of transducer elements through the shim and the bending elements to act as a heat sink for the piezo electric transducer elements. The method further comprises driving the plurality of sub-arrays to cause each of the sub-arrays to emit ultrasonic energy based on the nominal resonant frequency associated with each sub-array.

According to another aspect of the disclosure, there is provided an acoustic transducer device including a plate including a plurality of openings therein; a plurality of transducer elements, each being coupled to a bending element of a respective opening of the plurality of openings; a first impedance matching plate including a first plurality of regions of holes formed therein, each of the first plurality of regions of holes being positioned over an associated one of the bending elements; a second impedance matching plate including a second plurality of regions of holes formed therein, each of the second plurality of regions of holes being aligned with an associated one of the first plurality of regions of holes; and a shim disposed between the plate and the impedance matching plate, the shim including a plurality of openings therein, each of the openings being positioned over an associated one of the bending elements to establish an air gap between the associated one of the bending elements and an associated one of the first plurality of regions of holes of the impedance matching plate.

Embodiments of the methods described herein may be implemented using a processor and/or other programmable device. To that end, the methods described herein may be implemented on a tangible computer readable medium having instructions stored thereon that when executed by one or more processors perform the methods. Thus, for example, controller 104 may include a storage medium (not shown) to store instructions (in, for example, firmware or software) to perform the operations described herein. The storage medium may include any type of tangible medium, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

Elements, components, modules, and/or parts thereof that are described and/or otherwise portrayed through the figures to communicate with, be associated with, and/or be based on, something else, may be understood to so communicate, be associated with, and/or be based on in a direct and/or indirect manner, unless otherwise stipulated herein.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements. As used herein, use of the term “nominal” or “nominally” when referring to an amount means a designated or theoretical amount that may vary from the actual amount.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Also features of any embodiment described herein may be combined or substituted for features of any other embodiment described herein.

While the principles of the disclosure have been described herein, it is to be understood by those skilled in the art that this description is made only by way of example and not as a limitation as to the scope of the disclosure. Other embodiments are contemplated within the scope of the present disclosure in addition to the embodiments shown and described herein. Modifications and substitutions by one of ordinary skill in the art are considered to be within the scope of the present disclosure, which is not to be limited except by the following claims.

What is claimed is:

1. An acoustic transducer device comprising:
a plate including a plurality of openings therein;
a plurality of transducer elements, each being coupled to a bending element of a respective opening of the plurality of openings;
an impedance matching plate including a plurality of regions of holes formed therein, each of the plurality of regions of holes being positioned over an associated one of the bending elements; and
a shim disposed between the plate and the impedance matching plate, the shim including a plurality of openings therein, each of the plurality of openings being positioned over an associated one of the bending elements to establish an air gap between the associated one of the bending elements and an associated one of the plurality of regions of holes,
the impedance matching plate being thermally coupled to the plurality of transducer elements through the shim and the bending elements to act as a heat sink for the plurality of transducer elements.

2. The acoustic transducer of claim 1 further comprising a second impedance matching plate having a second plurality of regions of holes formed therein, each of the second plurality of regions of holes being aligned with an associated one of the plurality of regions of holes.

3. The acoustic transducer of claim 2, wherein the impedance matching plate and the second impedance matching plate each have an associated alignment feature for aligning the second plurality of regions of holes with associated ones of the plurality of regions of holes.

4. The acoustic transducer of claim 3, wherein the alignment features comprise a V-shaped notch defined by side surfaces extending inwardly from a perimeter of each of the impedance matching plate and the second impedance matching plate and meeting at an apex.

5. The acoustic transducer of claim 4, wherein one of the side surfaces comprises a V-shaped sub-notch formed therein and defined by sub-notch side surfaces extending inwardly from the one of the side surfaces and meeting at a sub-notch apex.

6. The acoustic transducer of claim 1, wherein the shim is integrally formed with the plate or the impedance matching plate.

7. The acoustic transducer of claim 1, wherein the plurality of transducer elements are piezo-electric transducer elements.

8. A method of deterring wildlife from an area comprising:
providing a plurality of sub-arrays coupled to a base portion, each of the plurality of sub-arrays being associated with a nominal resonant frequency and comprising
a sub-array plate including a plurality of openings therein;
a plurality of transducer elements, each of the plurality of transducer elements being coupled to a bending element of a respective opening of the plurality of openings;
an impedance matching plate including a plurality of regions of holes formed therein, each of the plurality of regions of holes being positioned over an associated one of the bending elements; and
a shim disposed between the sub-array plate and the impedance matching plate, the shim including a plurality of openings therein, each of the plurality of openings being positioned over an associated one of the bending elements to establish an air gap between the associated one of the bending elements and an associated one of the plurality of regions of holes,
the impedance matching plate being thermally coupled to the plurality of transducer elements through the shim and the bending elements to act as a heat sink for the plurality of transducer elements; and
driving the plurality of sub-arrays to cause each of the plurality of sub-arrays to emit ultrasonic energy based on the nominal resonant frequency associated with each of the plurality of sub-arrays.

9. The method of claim 8, wherein each of the plurality of sub-arrays further comprises a second impedance matching plate having a second plurality of regions of holes formed therein, each of the second plurality of regions of holes being aligned with an associated one of the plurality of regions of holes.

10. The method of claim 9, wherein the impedance matching plate and the second impedance matching plate each have an associated alignment feature for aligning the second plurality of regions of holes with associated ones of the plurality of regions of holes.

11. The method of claim 10, wherein the alignment features comprise a V-shaped notch defined by side surfaces extending inwardly from a perimeter of each of the impedance matching plate and the second impedance matching plate and meeting at an apex.

12. The method of claim 11, wherein one of the side surfaces comprises a V-shaped sub-notch formed therein and defined by sub-notch side surfaces extending inwardly from the one of the side surfaces and meeting at a sub-notch apex.

13. The method of claim 8, wherein the shim is integrally formed with the sub-array plate or the impedance matching plate.

14. An acoustic transducer device comprising:
a plate including a plurality of openings therein;
a plurality of transducer elements, each being coupled to a bending element of a respective opening of the plurality of openings;
a first impedance matching plate including a first plurality of regions of holes formed therein, each of the first plurality of regions of holes being positioned over an associated one of the bending elements; and
a second impedance matching plate including a second plurality of regions of holes formed therein, each of the second plurality of regions of holes being aligned with an associated one of the first plurality of regions of holes; and
a shim disposed between the plate and the impedance matching plate, the shim including a plurality of openings therein, each of the plurality of openings being positioned over an associated one of the bending elements to establish an air gap between the associated one of the bending elements and an associated one of the first plurality of regions of holes.

15. The acoustic transducer of claim 14, wherein the impedance matching plate and the second impedance matching plate each have an associated alignment feature for aligning the second plurality of regions of holes with associated ones of the plurality of regions of holes.

16. The acoustic transducer of claim 15, wherein the alignment features comprise a V-shaped notch defined by side surfaces extending inwardly from a perimeter of each of the impedance matching plate and the second impedance matching plate and meeting at an apex.

17. The acoustic transducer of claim 16, wherein one of the side surfaces comprises a V-shaped sub-notch formed therein and defined by sub-notch side surfaces extending inwardly from the one of the side surfaces and meeting at a sub-notch apex.

18. The acoustic transducer of claim 14, wherein the first impedance matching plate is thermally coupled to the plurality of transducer elements through the shim and the bending elements to act as a heat sink for the plurality of transducer elements.

19. The acoustic transducer of claim 14, wherein the shim is integrally formed with the plate or the impedance matching plate.

20. The acoustic transducer of claim 14, wherein the plurality of transducer elements are piezo-electric transducer elements.
